(19) United States
(12) Patent Application Publication
(10) Pub. No.: US 2006/0103701 A1
(43) Pub. Date: May 18, 2006

(54) Ink cartridge with semiconductor storage device

(75) Inventor: Alan K. Chan, Fairport, NY (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Nu-kote International, Inc.

(21) Appl. No.: 10/990,634

(22) Filed: Nov. 17, 2004

(51) Int. Cl. B41J 2/175

(52) U.S. Cl. 347/86

(57) ABSTRACT

A cartridge is provided for use with an associated printing apparatus. The cartridge includes a housing, a semiconductor storage device for storing data, a plurality of contacts for connecting the semiconductor storage device with an associated printing apparatus, and a printed circuit board held in a fixed relationship relative to the cartridge housing. The printed circuit board is rigid or otherwise relatively inflexible and defines a pair of opposite sides. The semiconductor storage device and the plurality of contacts are disposed exclusively on one of the pair of opposite sides of the printed circuit board.

### BACKGROUND OF THE INVENTION

This application relates to consumable devices used in connection with associated printing apparatus and, more particularly, to ink and toner cartridges having an electronic device storing information relating to the printing apparatus and/or to the ink toner cartridges. In its preferred form, the electronic device is a semiconductor memory device disposed on a single-sided rigid printed circuit board which is in turn mounted to the cartridge. It will be appreciate, however, that the invention may find application in related environments and any other applications where printed circuit boards are used on or in connection with cartridges or housings storing a consumable material.

It is generally known in the art to form an ink or toner cartridge or housing or body from a plastic material. These housings include one or more cavities or chambers that hold a predetermined supply of a marking material such as ink or toner. In addition, one or more receiving areas are provided on the housing for adapting the housing to support a printed circuit board carrying a set of contacts on a first side thereof and a semiconductor storage device storing information about the marking material on a second or back side thereof.

FIGS. 1(a) and 1(b) illustrate one such prior art ink cartridge 10 which is adapted for mounting an associated ink jet printing apparatus (not shown). The cartridge 10 has a container 11 and a lid 12. A printed circuit board 13 is located on a selected wall of the cartridge 10. The printed circuit board 13 carries a plurality of electrical contacts 14 on a first side 15 thereof (FIG. 1a) , and a memory device 16 on a back side 17 thereof (FIG. 1b). When the cartridge 10 is mounted onto the associated printing apparatus, a controller (not shown) in the printing apparatus is electrically connected to the memory device 16 through the electrical contacts 14. The controller selectively reads and writes data regarding the cartridge 10 from the memory device 16. The data typically includes information about the marking material, namely ink or toner, contained within the housing. Therefore, when the cartridge 10 is remounted to the printing apparatus after being removed therefrom, the controller within the printing apparatus can determine the quality and amount of ink remaining in the cartridge 10.

The printed circuit board 13 illustrated in FIGS. 1(a) and 1(b) typifies the prior art approach of providing memory on a cartridge whereby a plurality of contacts 14 are formed on a first side 15 of the printed circuit board 13 while the semiconductor memory device 16 is provided on the second side 17 of the printed circuit board. It is believed that the positioning of the memory device 16 on the second side 17 of the printed circuit board 13 protects the memory device from damage. Generally, however, the double sided printed circuit board approach is not very reliable due to the longer traces and the number of feed throughs that must be formed extending from one side of the circuit board to the other.

In addition to the above, the location of the semiconductor memory device 16 on the second side 17 of the printed circuit board 13 requires that a space or cavity 18 be provided between the back side 17 of the printed circuit board 13 and the outer face surface 19 of the main body 11 of the cartridge 10. This wastes space and makes placement of the printed circuit 13 onto the cartridge 10 difficult during manufacture.

Single-sided flexible circuit boards have been used in the past to provide an electronic storage device and electrical connections thereto for use in association with ink jet cartridges. However, flexible circuit boards have special application requirements. They can only be glued onto flat rigid surfaces and, therefore, require that a special receiving area must be provided on the cartridge housing body. Additionally, flexible circuit boards cannot be easily located on housing bodies using rigid pins or the like extending from the housing body because they easily deform during the manufacturing process.

### SUMMARY OF THE INVENTION

The present invention provides a cartridge for use with an associated printing apparatus including a housing and a single-sided rigid printed circuit board having a semiconductor storage device and a plurality of contacts on a single side of the rigid printed circuit board.

The subject invention provides a cartridge for use with an associated printing apparatus. The cartridge includes a housing, a semiconductor storage device, a plurality of contacts, and a single-sided rigid printed circuit board mounted to the housing. The housing defines a chamber for holding a marking material such as ink or toner within the housing. The semiconductor storage device stores information about the marking material. A plurality of contacts are provided on the printed circuit board for connecting the semiconductor storage device with the associated printing apparatus. The preferred printed circuit board defines a pair of opposite sides, the semiconductor storage device and the plurality of contacts being disposed exclusively on one of the pair of opposite sides of the printed circuit board. In a first embodiment, the semiconductor storage device is mounted directly to the same side of the printed circuit board as is the plurality of contacts. In another embodiment, an integrated circuit (IC) socket is mounted to the circuit board on the side with the contacts and the semiconductor storage device is received in the socket.

A primary advantage of the invention resides in a reduced cost of the printed circuit board and of the overall cartridge.

Another advantage of the invention relates to the ability to provide a more reliable electronic circuit on a cartridge for use with an associated printing apparatus.

Still another advantage is an improvement in design and manufacturing efficiencies. To that end, the single-sided rigid printed circuit board eliminates the need in the design of the cartridge to provide for a cavity or space for accommodating electronic components on the unused side of the printed circuit board. Also, during manufacturing, the ability to locate the single-sided printed circuit board relative to the housing is greatly enhanced.

Yet another advantage through use of the IC socket is the ability to construct the cartridge with the socket during a first phase of manufacture, then add the semiconductor storage device when available or needed during a subsequent phase of manufacture and/or distribution of the cartridge.

Still other advantages and benefits of the invention will become apparent to those skilled in the art upon reading and understanding the following detailed description.

### BRIEF DESCRIPTION OF THE DRAWINGS

The invention may take form in certain components, structures, and steps, the preferred embodiments of which will be illustrated in the accompanying drawings.

FIGS. 1(a) and (b) are perspective and cross-sectional views showing an ink cartridge of the prior art;

FIG. 2 is a perspective view showing an embodiment of an ink cartridge with a single-sided printed circuit board in accordance with the invention;

FIGS. 2a and 2b are cross-sectional views of the ink cartridge shown in FIG. 2 taken along line A-A illustrating first and second embodiments of a mounting arrangement for attaching the printed circuit board onto the ink cartridge;

FIGS. 3a and 3b are front and rear perspective views, respectively, of a single-sided printed circuit board in accordance with a first embodiment

FIGS. 4a and 4b are front and rear perspective views, respectively, of a single-sided printed circuit board in accordance with a second embodiment;

FIGS. 5a and 5b are front and rear perspective views, respectively, of a single-sided printed circuit board in accordance with another embodiment;

FIG. 6 is a cross-sectional view of an ink cartridge showing a single-sided printed circuit board mounted thereon in accordance with a first embodiment of the invention; and,

FIGS. 7a-7h are front elevational views showing alternative layouts of a single-sided printed circuit board for use in association with a consumable ink or toner cartridge.

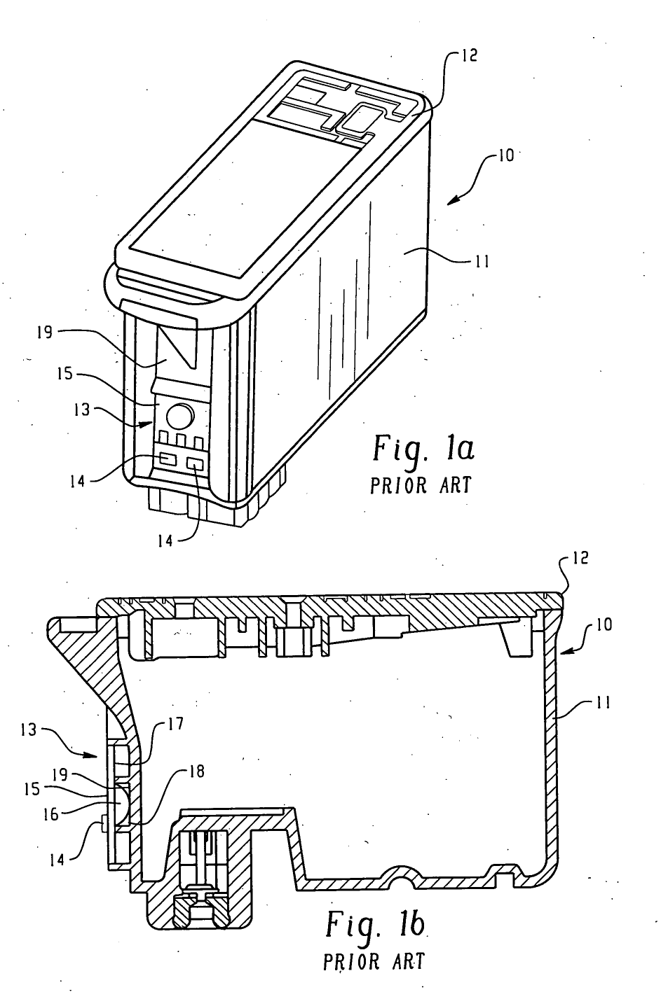

### DETAILED DESCRIPTION

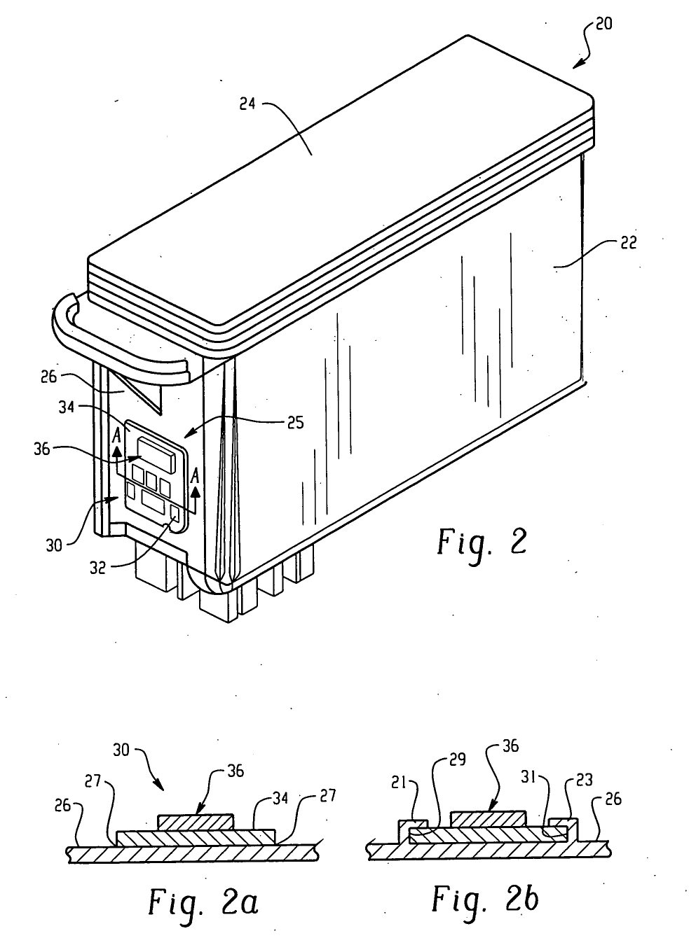

With reference now to FIG. 2, an ink cartridge 20 is shown. The cartridge is adapted for mounting with an associated ink jet printing apparatus (not shown). The cartridge 20 includes a container 22 having an inner surface (not shown) defining a chamber for holding ink or other marking material therein, and a lid 24. In accordance with the invention, a single-sided rigid printed circuit board 30 is disposed in a receiving area 25 on a front outer face side 26 of the cartridge 20. In the embodiment illustrated, the printed circuit board 30 carries a plurality of electrical contacts 32 on a first side 34 thereof, and an electronic device 36 mounted directly to the first side 34. It is to be appreciated that, in accordance with the present invention, both the electronic device 36 as well as the plurality of electrical contacts 32 are carried on a single first side 34 of the printed circuit board 30. When the cartridge 20 is mounted into the associate printing apparatus, a controller (not shown) in the printing apparatus is electrically connected to the electronic device 36 through the plurality of electrical contacts 32 arranged on the first side surface 34 of the printed circuit board 30.

FIG. 2a is a cross-sectional view taken along line A-A of FIG. 2 illustrating a first alternative embodiment for mounting the printed circuit board 30 on the front face side 26 of the ink cartridge 20. In the embodiment illustrated, the printed circuit board 30 is mounted directly in abutment with the front face side 26 of the ink cartridge 20 using a layer of a suitable adhesive 27 such as epoxy or the like. FIG. 2b shows a further alternative embodiment for mounting the printed circuit board 30 to the front face side 26 of the ink cartridge 20 by means of a pair of spaced apart “L” shaped finger members 21, 23 defining opposing slots 29, 31 adapted to slidingly receive opposite edges of the printed circuit board and carry the printed circuit board relative to the housing. Other alternative equivalent embodiments for mounting the printed circuit board to the ink cartridge are also possible such as, for example, providing a slot or groove in the housing body and positioning at least one edge of the circuit board in the slot or groove with the board extending substantially perpendicularly from a side of the cartridge.

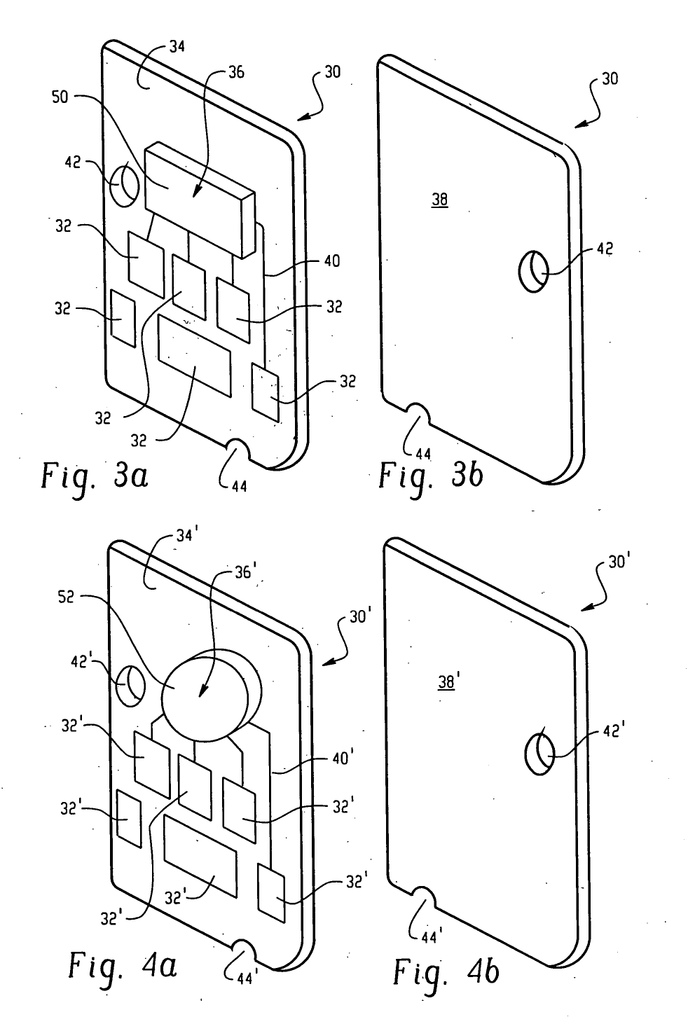

FIG. 3a is a perspective view of the first side 34 of the printed circuit board 30 while FIG. 3b shows a second or back side 38 of the printed circuit board 30.

In accordance with the present invention, the printed circuit board 30 is a single-sided rigid printed circuit board. In the first embodiment illustrated, the circuit board carries the electronic device 36 as well as the plurality of electrical contacts 32 directly on the first side 34 of the board.

In another embodiment to be described below, the electronic device is received in a socket directly on the first side of the printed circuit board.

FIG. 3b shows that none of the electrical components are disposed on the second or rear side 38 of the printed circuit board 30. A plurality of electrical traces 40 are disposed on the first side 34 of the printed circuit board for connecting the electronic device 36 to the plurality of electrical contacts 32 for electrical communication with the associated printing apparatus (not shown) when the subject ink cartridge 20 is mounted therein. With continued reference to FIGS. 3a and 3b, the preferred single-sided rigid printed circuit board 30 selectively includes at least one locating through hole 42 and a concave portion 44 for use in assisting the positioning of the single-sided printed circuit board 30 onto the front face side 26 of the container 22 during manufacture. In FIG. 3a, the electronic device 36 is a programmable microcontroller 50 including a processor and a memory unit (not shown).

FIGS. 4a and 4b illustrate an alternative embodiment of the preferred single-sided rigid printed circuit board 30′ formed in accordance with another aspect of the invention. As shown there, the single-sided printed circuit board 30′ includes an electronic device 36′ disposed on a front side 34 of the printed circuit board and in electrical communication with a plurality of electric contacts 32′ through a corresponding set of electronic traces 40′. As with the first preferred embodiment described above, the second or back side 38′ of the printed circuit board 30′ is void of any (includes no) electronic or electrical components, thus reducing the cost of the single-sided printed circuit board. At least one locating through hole 32′ and a concave portion 44′ are selectively provided for enabling easy positioning of the printed circuit board 30′ on the front face side 26 of the ink cartridge 20 during manufacture. In FIGS. 4a and 4b, the electronic device 36 is preferably an application specific integrated circuit (ASIC) chip 52 although any other integrated circuit devices can be used.

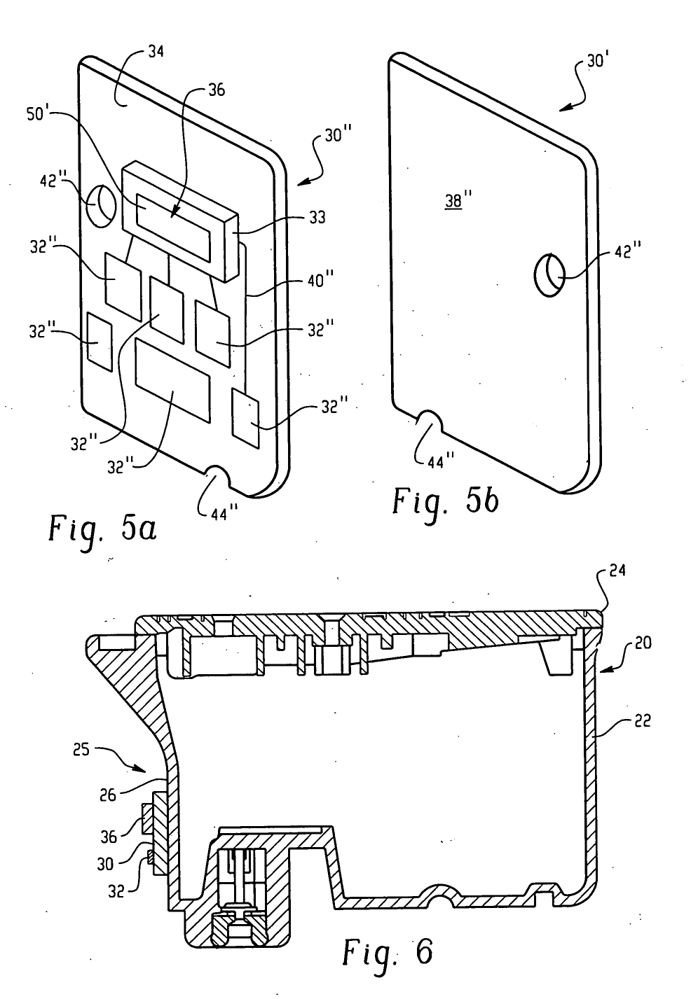

FIGS. 5a and 5b illustrate a further embodiment of the preferred single-sided rigid printed circuit board 30″ formed in accordance with another aspect of the invention. As shown there, the single-sided printed circuit board 30″ includes an electronic device 36″ disposed on a front side 34″ of the printed circuit board and in electrical communication with a plurality of contacts 32″ through a corresponding set of electronic traces 40″. In this embodiment, the electronic device 36″ is received in an integrated circuit (IC) socket 33. The socket 33 can take on any form including PQFP, dual-in-line, PLCC, pin grid array, surface mount, or the like in accordance with the characteristics of the electronic device 36″. As with the first preferred embodiment described above, the second or back side 38″ of the printed circuit board 30″ is void of any electronic or electrical components, thus reducing the cost of the single-sided printed circuit board. At least one locating through hole 32″ and a concave portion 44″ are selectively provided for enabling easy positioning of the printed circuit board 30″ on the front face side 26 of the ink cartridge 20 during manufacture. In FIGS. 5a and 5b, the electronic device 36″ is preferably a programmable microcontroller 50′ including a processor and a memory unit (not shown).

FIG. 6 is a cross-sectional view of the subject ink cartridge 20 carrying a single-sided rigid printed circuit board 30 on a front face surface 26 thereof. As shown, the printed circuit board 30 carries one or more of an electronic device 36 and a plurality of electrical contacts 32 for interfacing the electronic device 36 with an associated printing apparatus (not shown). As illustrated, the rigid single-sided printed circuit board 30 has a flat back side 38 adapted to directly engage and interface with the front face 26 of the ink cartridge body 22. This reduces the overall space required for mounting the ink cartridge 20 into the associated printing apparatus. Preferably, substantially the entire surface of the flat back side 38 of the printed circuit board 30 is held in contact with the flat surface area 26 of the receiving area 25 using a suitable mechanical connection such as welded tabs, an adhesive material, or the like.

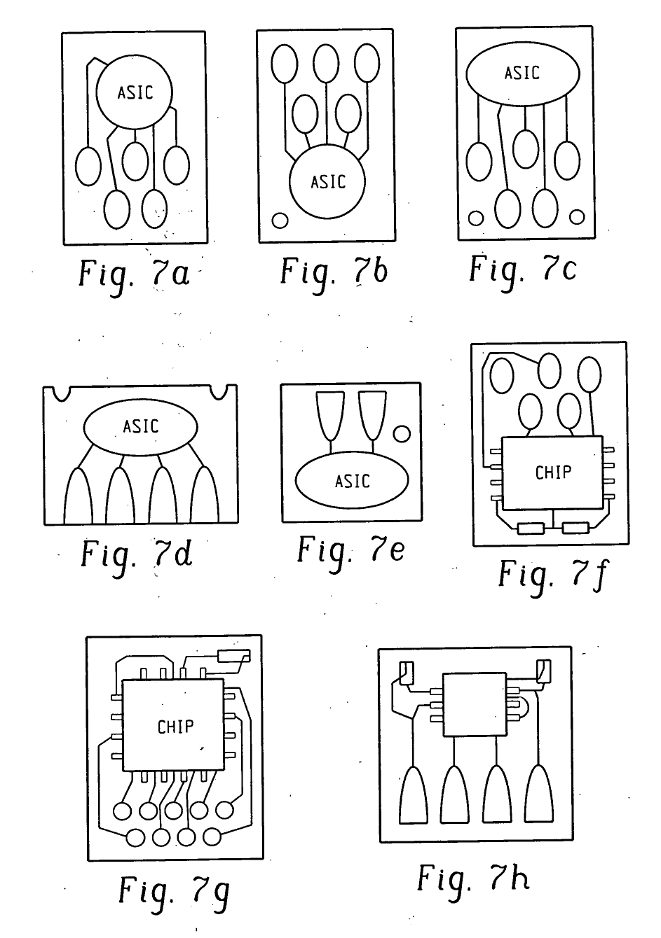

FIGS. 7a-7h show alternative embodiments of the subject rigid single-sided printed circuit board used in conjunction with an ink or toner cartridge in accordance with the invention. It is to be appreciated that FIGS. 7a-7h show only the front face of the single-sided printed circuit board and that the back face of each of the embodiments illustrated in the Figures is as shown in FIGS. 3b, 4b or 5b.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof. As an example, the substantially rigid circuit board can be mounted to any of a variety of devices carrying or storing consumable materials such as, for example, toner cartridges, paint or other marking material containers, chemical storage devices and consumer or commercial products or devices.

1. A cartridge for use with an associated printing apparatus, the cartridge comprising:
a housing defining a chamber for holding a marking material within the housing;
a semiconductor storage device storing information about the marking material;
a plurality of contacts for connecting the semiconductor storage device with the associated printing apparatus; and,
a rigid printed circuit board held in a fixed relationship relative to said housing, the printed circuit board defining a pair of opposite sides, said semiconductor storage device and said plurality of contacts being disposed exclusively on a one of said pair of opposite sides of the printed circuit board.

2. The cartridge according to claim 1 wherein:
the housing has a first inner surface defining said chamber, and a first outer surface, a portion of the first outer surface defining a receiving area adapted to carry the printed circuit board; and,
the printed circuit board is held in said fixed relationship relative to said housing at said receiving area.

3. The cartridge according to claim 2 wherein:
said receiving area defines a flat surface area of said first outer surface of the housing; and,
the printed circuit board is held at said receiving area with the other of said pair of opposite sides in abutment with said flat surface area.

4. The cartridge according to claim 3 wherein substantially the entire surface of said other of said pair of opposite sides of said printed circuit board is held in contact with said flat surface area

5. The cartridge according to claim 2 wherein said printed circuit board is held at said receiving area in abutment with said flat surface area using an adhesive.

6. The cartridge according to claim 2 wherein:
said receiving area defines at least one slot adapted to receive an edge of said printed circuit board and carry the printed circuit board relative to said housing.

7. The cartridge according to claim 2 wherein:
said receiving area defines a pair of spaced apart slots adapted to slidingly receive opposite edges of said printed circuit board and carry the printed circuit board relative to the housing.

8. The cartridge according to claim 1 wherein said chamber of said housing is adapted to hold a one of a toner material and ink.

9. The cartridge according to claim 1 further including an integrated circuit socket on said printed circuit board adapted to selectively receive said semiconductor storage device.

10. The cartridge according to claim 9 wherein said integrated circuit socket is a one of a PQFP socket, a dual-in-line socket, a PLCC socket, a pin grid array socket, and a surface mount socket.

11. An ink cartridge for mounting on a carriage of an ink jet printing apparatus and for supplying ink to a printhead of said ink jet printing apparatus through an ink supply needle, the ink cartridge comprising:
a plurality of external walls, including a first wall and a second wall, defining at least some of a chamber;
an ink supply port for receiving said ink supply needle, the ink supply port having a center line and communicating with the chamber;
a substrate disposed on said second wall;
a semiconductor storage device storing information about the ink carried by said cartridge, the semiconductor storage device being disposed on a first side of said substrate; and,
a plurality of contacts for connecting the semiconductor storage device to the ink jet printing apparatus, the contacts being formed on said first side of said substrate.

12. The ink cartridge according to claim 11 wherein:
said ink supply port is formed in said first wall; and,
said substrate is disposed on said second wall.

13. The ink cartridge according to claim 12 wherein said substrate is a substantially rectangular printed circuit board.

14. The ink cartridge according to claim 13 wherein said printed circuit board is held relative to said ink cartridge in a position substantially in parallel with said second wall which is perpendicular to said first wall of said housing.

15. The ink cartridge according to claim 14 further including an integrated circuit socket carried on said substrate and adapted to selectively receive said semiconductor storage device therein.

16. The ink cartridge according to claim 15 wherein said integrated circuit socket is a one of a PQFP socket, a dual-in-line socket, a PLCC socket, a pin grid array socket, and a surface mount socket.

17. An apparatus for use with a cartridge in an associated printing apparatus, the cartridge including a housing defining a chamber for holding a marking material within the housing, the apparatus comprising:
a semiconductor storage device storing information about the marking material;
a plurality of contacts for connecting the semiconductor storage device with the associated printing apparatus; and,
a rigid printed circuit board held in a fixed relationship relative to said housing, the printed circuit board defining a pair of opposite sides, said semiconductor storage device and said plurality of contacts being disposed exclusively on one side of the printed circuit board.
